(19) United States
(12) Patent Application Publication
(10) Pub. No.: US 2007/0266488 A1
(43) Pub. Date: Nov. 22, 2007

(54) BIDET HAVING FUNCTION OF AUTOMATICALLY ADJUSTING HUMAN BODY DETECTION DISTANCE

(75) Inventor: Byung-Woon JEON, Suwon-si (KR)

Correspondence Address: CANTOR COLBURN, LLP, 55 GRIFFIN ROAD SOUTH, BLOOMFIELD, CT, 06002, US

(73) Assignee: NOVITA CO., LTD., Cheonan-si (KR)

(21) Appl. No.: 11/553,827

(22) Filed: Oct. 27, 2006

(30) Foreign Application Priority Data
May 22, 2006 (KR) 20-2006-0013646

(51) Int. Cl. A47K 3/26; A47K 3/022; A61H 35/00

(52) U.S. Cl. 4/443

(57) ABSTRACT

A bidet having a function of automatically adjusting a human body detection distance includes a key part provided with a specific key for automatically adjusting a human body detection distance, a microcomputer outputting a control signal for adjusting the human body detection distance when a user inputs the specific key, an output varying means driven by the control signal from the microcomputer and a human body sensor for outputting a human body detection signal while sequentially increasing the human body detection distance from a minimum distance setting signal as the output varying means is driven, and detecting the signal reflected from the human body to store a distance setting output signal to an EEPROM.

### CROSS-REFERENCE TO RELATED APPLICATION

This application claims the benefit of Korean Utility Model Application No. 20-2006-0013646, filed May 22, 2006, the disclosure of which is hereby incorporated herein by reference in its entirety.

### BACKGROUND OF THE INVENTION

1. Field of the Invention

The present invention relates to a bidet having a function of automatically adjusting a human body detection distance and, more particularly, to a bidet having a function of automatically adjusting a human body detection distance capable of automatically detecting a human body and recognizing a distance from a sensor to the body in response to simple key manipulation of a user. As a result, the bidet is convenient to use and requires no difficult button manipulation according to variation of use environment. The bidet may be a general bidet or a bidet that automatically flushes by detecting a human body.

2. Description of the Related Art

Generally, a warm-water cleaner (hereinafter, referred to as “bidet”) is used to clean the rectal area and genitals.

The bidet performs functions of cleaning the rectal area after a bowel movement using cleaning water ejected through a nozzle, without tissue, automatically cleaning a woman's genitals using the cleaning water, and massaging the genitals by continuously reciprocating the nozzle ejecting the cleaning water.

The conventional bidet includes a water supply means for supplying cleaning water, a storage tank for storing water, a heating means for heating the storage tank to maintain the water in the storage tank at a certain temperature, a control means for adjusting an amount of water discharged from the storage tank, a key part having a plurality of keys for setting a power saving mode, and setting temperatures of warm water and a closet seat cover during a power saving mode, a cleaning nozzle for ejecting water discharged from the storage tank to a user's rectal area, a bidet nozzle for ejecting water discharged from the storage tank to a user's genitals, a nozzle cleaning part for supplying water discharged from the storage tank to the cleaning nozzle and the bidet nozzle to clean the nozzles, and a seating sensor for detecting whether a user is seated on a closet seat.

The seating sensor may be classified as a sensor for determining whether a user is seated on a closet seat by detecting weight, or a sensor for determining whether a user is seated by detecting the user's proximity.

FIG. 1 illustrates a seating sensor 1, i.e., a human body sensor, for detecting whether a user is within a certain proximity, installed at a bidet.

The human body sensor 1 is installed in the front of a main body of the bidet to detect whether or not a human body is seated on a closet seat or approaches adjacent to the closet seat, using infrared light emitted from the sensor and reflected by the human body.

However, since the conventional human body sensor 1 is set to detect the human body within a predetermined distance, when a user such as a child, a senior citizen, or a physically handicapped person is seated on a front part of the closet seat, the human body sensor 1 may fail to detect the user, or may incorrectly detect the user when standing in front of the human body sensor.

### SUMMARY OF THE INVENTION

In order to solve the foregoing and/or other problems, it is an aspect of the present invention to provide a bidet having a function of automatically adjusting a human body detection distance capable of automatically detecting a human body and recognizing a distance from a sensor to the body in response to simple key manipulation of a user. As a result, the bidet is convenient to use and requires no difficult button manipulation according to variation of use environment. The bidet may be a general bidet or a bidet that automatically flushes by detecting a human body.

Additional aspects and advantages of the present invention will be set forth in part in the description which follows and, in part, will be obvious from the description, or may be learned by practice of the invention.

The foregoing and/or other aspects of the present invention may be achieved by providing a bidet having a function of automatically adjusting a human body detection distance, the bidet including: a key part provided with a specific key for automatically adjusting a human body detection distance; a microcomputer for outputting a control signal for adjusting the human body detection distance when a user inputs the specific key; an output varying means driven by the control signal from the micro computer; and a human body sensor for outputting a human body detection signal while sequentially increasing the human body detection distance from a minimum distance setting signal as the output varying means is driven, and detecting the signal reflected from the human body to store a distance setting output signal to an EEPROM.

### BRIEF DESCRIPTION OF THE DRAWINGS

These and/or other aspects and advantages of the present invention will become apparent and more readily appreciated from the following description of exemplary embodiments, taken in conjunction with the accompanying drawings of which:

FIG. 1 is a perspective view of a bidet at which a conventional human body sensor is installed; and

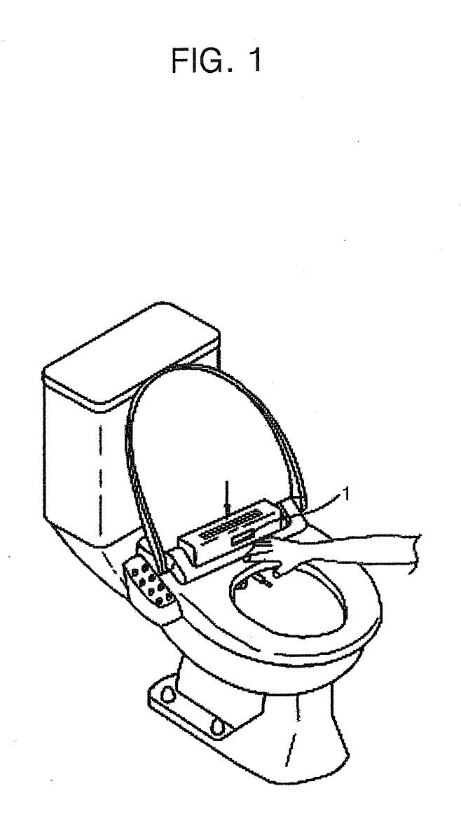

FIG. 2 is a block diagram of a bidet having a function of automatically adjusting a human body detection distance in accordance with the present invention.

### DETAILED DESCRIPTION OF THE INVENTION

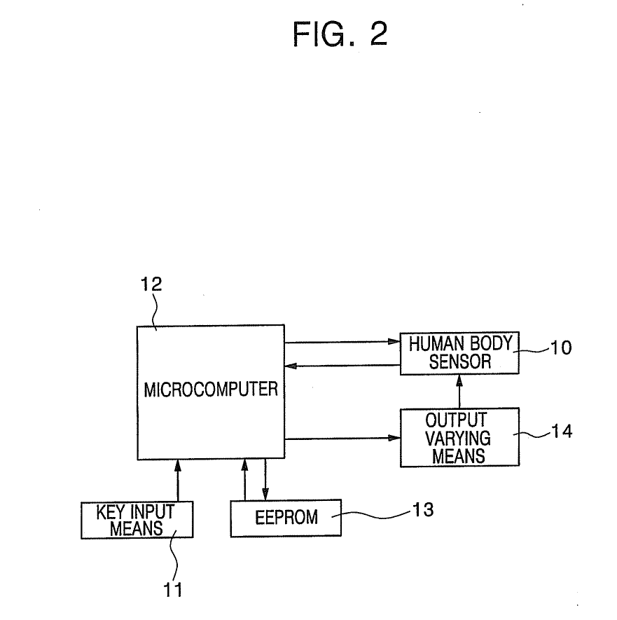

Hereinafter, an exemplary embodiment of the present invention will be described with reference to FIG. 2.

A bidet having a function of automatically adjusting a human body detection distance in accordance with an exemplary embodiment of the present invention includes a key part 11 provided with a specific key for automatically adjusting a human body detection distance; a microcomputer 12 for outputting a control signal for adjusting the human body detection distance when a user inputs the specific key; an output varying means 14 for controlling the human body detection distance to sequentially increase from a minimum distance setting signal to a maximum distance setting signal under the control of the micro computer 12; and a human body sensor 10 for outputting a human body detection signal while sequentially increasing the human body detection distance from the minimum distance setting signal to the maximum distance setting signal under the control of the output varying means, and detecting the signal reflected from the human body to store a distance setting output signal to an EEPROM 13.

Operation of the bidet in accordance with an embodiment of the present invention will be described below.

When a user inputs the specific key provided in the key part 11, the microcomputer 12 converts the human body sensor 10 into a human body detection distance automatic adjustment mode, and the human body sensor 10 outputs a control signal for adjusting the human body detection distance to the output varying means 14.

The output varying means 14 drives the human body sensor 10 to output the human body detection signal while sequentially increasing from the minimum distance setting signal to the maximum distance setting signal under the control of the microcomputer 12. Accordingly, the human body sensor 10 outputs the human body detection signal while sequentially increasing from the minimum distance setting signal to the maximum distance setting signal under the control of the output varying means 14.

When the human body detection signal reflected by the human body is received, the human body sensor 10 stores the distance setting output signal to the EEPROM 13 and supplies the signal to the microcomputer 12, and the microcomputer 12 determines that the user is seated on the closet seat.

As described above, in accordance with an exemplary embodiment of the present invention, in a case of a bidet that flushes automatically by detecting a human body, it is possible to increase reliability of the automatic flushing by accurately performing the human body detection operation. In addition, even when a child, senior citizen, or handicapped person is seated on the closet seat, it is possible to precisely detect the seating on the closet seat to prevent malfunction of the bidet.

As can be seen from the foregoing, the present invention provides a bidet having a function of automatically adjusting a human body detection distance capable of automatically detecting a human body and recognizing a distance from a sensor to the body in response to simple key manipulation of a user. As a result, the bidet is convenient to use and requires no difficult button manipulation according to variation of use environment. The bidet may be a general bidet or a bidet that automatically flushes by detecting a human body.

Although a few exemplary embodiments of the present invention have been shown and described, it will be appreciated by those skilled in the art that changes may be made in these embodiments without departing from the principles and spirit of the invention, the scope of which is defined in the appended claims and their equivalents.

What is claimed is:

1. A bidet having a function of automatically adjusting a human body detection distance, the bidet comprising:
a key part provided with a specific key for automatically adjusting a human body detection distance;
a microcomputer outputting a control signal for adjusting the human body detection distance when a user inputs the specific key;
an output varying means driven by the control signal from the micro computer; and
a human body sensor outputting a human body detection signal while sequentially increasing the human body detection distance from a minimum distance setting signal as the output varying means is driven, and detecting the signal reflected from the human body to store a distance setting output signal to an EEPROM.

2. The bidet having a function of automatically adjusting a human body detection distance according to claim 1, wherein the microcomputer is converted into a human body detection distance automatic adjustment mode in response to input of the specific key.

3. The bidet having a function of automatically adjusting a human body detection distance according to claim 1, wherein the reflected human body detection signal is converted into the distance setting output signal to be stored in the EEPROM, and simultaneously, the microcomputer determines that the user is seated on a closet seat.
